(19) United States
(12) Patent Application Publication
(10) Pub. No.: US 2002/0069263 A1
(43) Pub. Date: Jun. 6, 2002

(54) Wireless java technology

(76) Inventors: Mark Sears, Calgary (CA); Tim Rahrer, Ottawa (CA); Stephen Gargan, San Diego, CA (US); Vincent Deschenes, Ottawa (CA)

Correspondence Address: Zucotto Wireless, c/o Mark Wards, Suite 400, 4225 Executive Square, La Jolla, CA, 92037, US

(21) Appl. No.: 09/966,345

(22) Filed: Sep. 28, 2001

Related U.S. Application Data
(60) Provisional application No. 60/240,454, filed on Oct. 13, 2000.
(60) Provisional application No. 60/307,965, filed on Jul. 26, 2001.
(60) Provisional application No. 60/247,403, filed on Nov. 9, 2000.
(60) Provisional application No. 60/316,734, filed on Aug. 31, 2001.

(51) Int. Cl. G06F 15/16

(52) U.S. Cl. 709/218

(57) ABSTRACT

An apparatus, method, and means are provided for seamless and optimized interaction between users, devices, and applications located in a network environment. The applications may be Java or Java-like applications, and the devices may be mobile communication devices.

### RELATED APPLICATIONS

This application is related to and claims priority from commonly assigned U.S. applications Ser. No. 60/240,454 filed on Oct. 13, 2000; Ser. No. 60/307,965 filed on Jul. 26, 2001; Ser. No. 60/247,403 filed on Nov. 9, 2000; Ser. No. 60/316,734 filed on Aug. 31, 2001; and Ser. No. 09/829,235 filed on Apr. 9, 2001.

### SCOPE

This application is generally related to an infrastructure that allows for seamless and optimized interactions to occur between users, devices, providers, and applications located in a network environment; and is more particularly related to applications that implement Java or Java-like technology in a wireless network.

### BACKGROUND

Consumers who live and work “on the fly” need full access to Internet style services and applications that may be as mobile as they are. This type of dynamic connected lifestyle is pushing mobile devices into a new era of utility as network appliances. Consumers expect mobile devices to support e-mail, e-commerce, gaming, and Internet browsing. Such diverse functionality requires an open standards-based networked technology platform that can bridge the gap between consumers, wireless carriers, device manufacturers, content providers, and application developers. However, until recently, the dissemination of wireless information was constrained. The accessibility to networks by individual mobile devices was limited by proprietary technology and applications.

Currently, content delivery to mobile devices can be implemented in two ways: with a markup language such as WML (Wireless Markup Language) used in the Wireless Application Protocol WAP or Compact HTML (cHTML), or with a portable application programming language such as Java. Use of these technologies can result in benefits as well as limitations, but Java technology provides a single open platform that allows developers to create dynamic, personal, and functionality-rich applications, which content providers can provide and deliver to mobile devices.

With WAP, a simple browser application built into a mobile device may display information downloaded over a wireless or other type of data link. Although WAP allows “scripts” that are run within the browser to be downloaded and executed, it does not provide a framework for downloading of generic applications for execution on mobile devices. Today's WAP devices act as dumb terminals to which text files are sent and rendered into static web pages. WAP on a mobile device is limited to providing static web browsing and basic graphics capabilities, a model that precludes the delivery of dynamic, interactive, and personal content.

Mobile device users want services and applications that can deliver individualized information. Factors other than personal preferences, such as location and circumstance, play a part in determining what exactly “individualized” means. For example, a tourist stranded at Heathrow airport in London, whose plane has just been cancelled will have different information needs than when en route to an office in San Jose, Calif. In the former case, important information might include the availability of other flights, the location of nearby hotels and restaurants, or information about entertainment that evening. In the latter case, important tasks might include booking a meeting, checking e-mail or traffic reports, or on-line trading.

Java technology enables developers to write rich dynamic personalized services and applications for use on mobile devices. In one embodiment, a mobile device, as described in commonly assigned U.S. application Ser. No. 09/871,483 filed May 31, 2001, may be used to execute Java programs that are as rich in content and usability as those executed on PC based platforms. Java technology-based applications support more content-rich graphics and faster interaction than browser-based environments (such as WAP or cHTML), enabling mobile devices to perform tasks as varied as e-mail, news updates, downloadable games, calendaring, and access to business data. Client-generated graphics may be vector-based, enabling a richer viewer experience and reduced network demand. As well, applications may be downloaded and run locally on client devices, and upgrades or new applications may be downloaded “on the fly.” With Java technology, applications and code may be brought to mobile devices and users such that they may both interact with each other.

While Java platforms may be open and allow developers to create applications that are portable, dynamic, and personal, these key features are not the only reason a Java solution is best suited for use with mobile devices. Java technology also offers the ability to ensure data security and to provide disconnected access-critical differentiators. A Java platform is inherently secure. Built-in features such as byte-code verification, no direct memory pointers, and digital signatures for dynamic applications provide a good security base. There are also multiple third-party extensions for Java platforms covering areas like authentication and cryptography. Portable Java applications can easily be written to be distributed over TCP/IP, eliminating the potential for security breaches during gateway protocol conversions, a risk that currently exists with WAP-based gateways. Unlike WAP-enabled devices, Java-enabled devices allow applications to reside on mobile devices so they can run even when a mobile device is out of a network's coverage area. Application processing need not, thus, be interrupted when a network is unavailable. A device or device user can also put certain tasks on hold until a network connection is reestablished. Java code can be dynamically and securely downloaded from remote servers, providing the proper environment to run applications locally on client devices, regardless of whether necessary library files were shipped with a particular device.

However, in contrast to personal computers (PC's), mobile devices are constrained by user interface, size, memory, and power limitations. Although markup languages may bring web surfing to mobile devices and the ability to download and save .zip or setup.exe files with which to install and run the files, this static model on a mobile device brings the PC paradigm to mobile devices without changing its context to suit the differing limited memory, limited power, and small display size environments of different mobile devices. With present mobile devices, users are not able to download and save all the applications they desire. With limited processing and memory resources, users need to load, run and delete those applications they use infrequently to save memory for those applications that are used daily. For example, limited memory of mobile devices may mean that resident virus checking software may be limited in its limitation. In addition, mobile device user interfaces make it difficult to “surf” for new applications.

Although Java environments allow for the development and widespread distribution of portable content-rich Internet applications to a PC desktop (e.g., games, investment portfolios, and calendars), the portability of such applications to memory-constrained, low-power mobile devices, while possible, has previously not been practical in terms of performance.

As more access to information “on the fly” becomes the standard, Java technology available from Sun Microsystems Inc., and Java-like technology available from various other manufacturers will be there to deliver it. However, the question remains, how can semi-compiled/interpreted or byte compiled languages like Java be utilized seamlessly within a communications network?

### SUMMARY

Aspects of the present invention include various embodiments. In one embodiment, the present invention includes a server that may be used as a central point of focus for users of mobile devices, carriers, network operators, content providers, application developers, and device manufacturers. In one embodiment, the present invention may provide a location for users to look for content and information; a service and content delivery platform for maintaining statistics and metrics for use by the users of mobile devices, carriers, network operators, content providers, application developers, and device manufacturers; and a location for manufacturers to upload information about their products for use by developers. In one embodiment the content and information may be Java information. In one embodiment, the content and information may be Java-like information. In one embodiment, the present invention comprises a location where the content and information maybe optimized for use by specific users or for use on specific mobile device platforms. In one embodiment, the applications may be qualified, for example, by authentication, for security, for trust level, and/or for compatibility. In one embodiment, applications may be altered or repackaged to include either a subset or superset of functionality required by users and devices in a network as determined by metrics and characteristics describing the applications, users, and devices. In one embodiment, user, device, and application metrics and characteristics may be stored on a network server. In one embodiment, based on the metrics and characteristics, applications and content may be qualified, processed, optimized, and/or customized prior to dissemination of the applications to users and/or devices in the network. In one embodiment, users may request applications and content and may be provided them based on the metrics and characteristics specific to the users and/or their devices. In one embodiment, customized search paths may be established by carriers and service providers that could be based on user preferences, past applications used, applications for sale, trusted applications, application provider, popular frequently used applications, cost, size, compatibility with currently stored applications and resources. In one embodiment, the present invention may provide a database of mobile device characteristics and capabilities. The database may be accessible through a secure connection by device manufacturers and to update when new products are released. In one embodiment, the database may also be accessible to information and content providers so as to provide and qualify content based on look up to the device characteristics and capabilities, for example, by device manufacturer name, device model number, or uniquely assigned I.D. numbers.

In one embodiment, a system for disseminating information to users and devices in a network may comprise: a server, wherein the server disseminates Java information to the users and devices in the network, wherein the Java information is disseminated to users and devices based on characteristics of the users and the devices; at least one computer readable medium comprising the characteristics of the users and devices; and a tool, wherein each computer readable medium, the tool, and the server are operatively coupled, wherein the tool processes the Java information based on the characteristics of the users and devices prior to dissemination. The Java information may comprise information submitted to the server by application developers. The Java information may comprise information submitted to the server by content providers and service providers. The server may disseminate the characteristics of the users and devices in the network to providers of the information. The Java information may comprise one or more application, wherein the computer readable medium further comprises characteristics of the one or more application, and wherein the server disseminates one or more of the characteristics to the network.

In one embodiment, a system for disseminating information may comprise: a server; and a plurality of mobile communication devices, wherein the server disseminates the information to the mobile communication devices according to characteristics of the mobile communication devices, and wherein the information comprises Java information.

In one embodiment, the system may comprise a tool, wherein the information comprises byte-codes, and wherein the tool processes the information by changing at least some of the byte-codes.

In one embodiment, the system may comprise a tool, wherein the information comprises byte-codes, and wherein the tool processes the information by adding byte-codes to the information.

In one embodiment, the system may comprise a tool, wherein the information comprises byte-codes, and wherein the tool processes the information by removing byte-codes from the information.

In one embodiment, a server for disseminating information to devices in a network may comprise: a tool, the tool for receiving information and for processing the information according to characteristics of the network, wherein the characteristics comprise characteristics of the devices. The devices may comprise mobile communication devices. The characteristics of the devices may be selected from a group consisting of display, memory, interface, processor, and installed software characteristics.

In one embodiment, a server for disseminating information to users in a network may comprise: a tool, the tool for receiving information and for processing the information according to characteristics of the network, wherein the characteristics comprise characteristics of the users. the characteristics of the users may be selected from a group consisting of download history, log of frequently used applications, billing and subscription info, user ranking of applications, applications used in the past, and download history.

In one embodiment, a method for disseminating information in a network may comprise the steps of: providing information to the network as byte-codes; processing the byte-codes according to characteristics of the network; and disseminating the processed byte-codes to the network. The step of processing may comprise adding byte-codes to the information, removing byte-codes from the information, and altering the byte-codes.

In one embodiment, a method for disseminating information in a network may comprise the steps of providing Java information to the network; processing the Java information according to characteristics of the network; and disseminating the processed Java information to the network. The method may further comprise the step of processing the Java information by processing byte-codes of the Java information. The method may further comprise the step of processing the information by qualifying, profiling, optimizing, or customizing the information.

In one embodiment, a method for disseminating information in a network may comprise the steps of: providing a JAR file to the network; processing the JAR file according to characteristics of one or more mobile devices in the network; and disseminating the processed JAR file to one or more mobile devices in the network.

In one embodiment, a method for disseminating information to devices and users in a network may comprise the steps of providing Java information to the network; optimizing the Java information according to characteristics of users and devices in the network; disseminating the processed Java information to the users and devices.

In one embodiment, a method for disseminating information to devices and users in a network may comprise the steps of: providing Java information to a server in the network; qualifying the Java information; and disseminating the qualified Java information to the users and devices.

In one embodiment, a method for disseminating information to devices in a network may comprise the steps of: storing Java information in the network to server; storing characteristics of a specific users and devices in the network to the server; disseminating the Java information in the network to specific users and devices in the network according to the characteristics of the specific users and devices. In one embodiment, a computer readable medium may comprise program instructions, wherein the program instructions interact with the a network to receive Java or Java-like information and to process the information according to characteristics of the network, wherein the characteristics comprise characteristics of devices in the network. The program instructions may interact with the network to disseminate the processed information to the network.

In one embodiment, a system for disseminating information to users and devices in a network may comprise a means for registering users and devices in the network; means for receiving information; means for processing the information based on characteristics of the users and devices in the network; and means for disseminating the processed information to the network.

These as well as other aspects of the invention discussed herein may be present in embodiments, in other combinations, separately, or in combination with other aspects and will be better understood with reference to the following Figures, description, and appended claims.

### BRIEF DESCRIPTION OF FIGURES

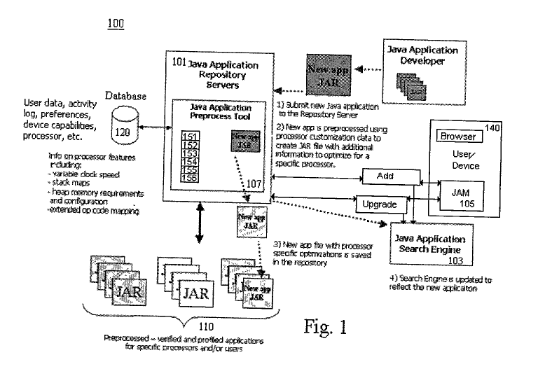

In FIG. 1 an infrastructure 100 including a repository server 101 is shown.

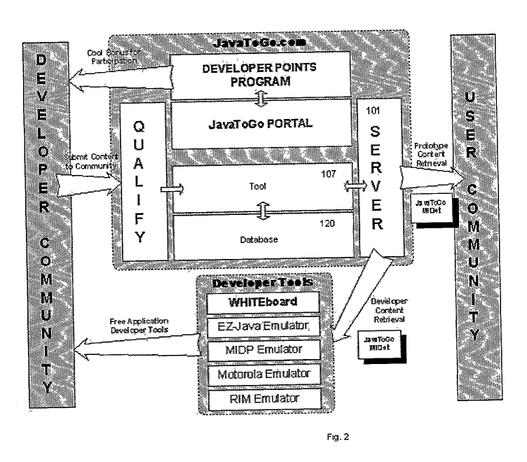

In FIG. 2 there is seen how free or low cost access to development tools, including from different vendors, and special incentives could be provided with or on the server 101 to build a developer community.

### DESCRIPTION

With the release of the Java 2 Micro Edition (J2ME) platform, and particularly the Connected Limited Device Configuration (CLDC) from Sun Microsystems™, a small-footprint Java runtime environment developed directly for the mobile device market is now available. CLDC specifies the features of the Java virtual machine (VM) and the core developer libraries to be used for small, low-power, memory-constrained devices. The J2ME platform was designed with closed environment security in mind so it can leverage the platform security features available in existing security infrastructures such as WAP or end-to-end solutions. Unlike WAP, J2ME does not create another Internet for devices, instead it provides a direct path for tying existing mobile devices into “the” Internet.

The J2ME Mobile Information Device Profile (MIDP), layered on top of CLDC, includes frameworks for application life cycles, HTTP networking, persistent data storage, and graphical user interfaces. Both CLDC and MIDP allow Java applications to deliver high-end security and graphics capabilities, along with the ability to download MlDlets (applications written using the MIDP framework) and store them on a device. Just like other Java applications, MlDlets are easy to create, install, upgrade, and port to different platforms.

Java technology enabled devices can offer dynamic and secure delivery of multiple applications and services in real time. Through CLDC and MIDP, J2ME provides a modular, scalable architecture to support the flexible deployment of technology to devices with diverse features, functions, and memory/performance capabilities. Such technology provides the next logical step in maximizing the portability of applications and the performance and memory of mobile devices. For wireless carriers, the Java platform enables traditional functionalities like e-commerce, stock trading, and banking to be extended into the wireless realm. For mobile wireless device manufacturers, Java technology means products may be capable of running a whole new generation of applications and services. For content providers, the cross-platform capability of Java programs reduces time to market and provides access to an entirely new set of customers.

While most current mobile devices run on proprietary platforms, such as Microsoft's WindowsCE or PalmOS™, the device as described in commonly assigned U.S. patent application Ser. No. 09/871,483 filed May 31, 2001, with its Java native processor and supporting software and hardware provides an open platform for mobile Internet device applications. The described processor natively executes Java byte-code and supports an optimized and enhanced J2ME/CLDC framework, and delivers to mobile devices an efficient, optimized balance between high speed and low power consumption. By designing device processors to integrate with existing technology, a future path for service providers and device manufacturers alike may be provided to seamlessly run the exciting rich content of next-generation mobile devices, as is described herein.

Referring now to FIG. 1, an embodiment of the present invention is shown. In one embodiment, a network infrastructure 100 is implemented to permit seamless and optimized interaction between users, devices, and applications located therein. Network 100 may have disposed therein, one or more repository server 101, one or more device 140, and one or more database 120. As described herein, one or more application 110 submitted to the infrastructure 100 may be pre-processed, verified, and/or profiled for use by devices 140 and/or users in the network 100. In one embodiment, devices 140 and/or users in the network 100 may be registered with a registry (not shown). In one embodiment, one or more of the devices 140 may comprise mobile devices that may communicate over a wireless medium. In one embodiment, one or more of the devices may comprise a cellular phone and/or a Personal Digital Assistant (PDA), but it is understood that the scope of the present invention may include other devices, as well as other wireless and wired devices and, thus, the present invention should be limited only by the claims as recited below. Furthermore, to the extent necessary to implement commonly known elements described herein, it is understood that those of ordinary skill in the art would be capable of doing so. For example, network, server, database, and mobile device technology discussed herein, may be implemented utilizing hardware, firmware, and software technologies that are well known in the art, and, thus, are not discussed in other than the detail necessary.

In one embodiment, a server 101 may communicate with one or more device 140 either directly, or through a proxy server or gateway server (not shown). The server 101 and the proxy or gateway server may or may not be co-located or owned by the same entity. In one embodiment, a server 101 may be implemented by one company focused on services, which may be made available via a connection to other customers'(ex. wireless carriers) wireless application proxy or gateway servers that communicate to the customers'wireless subscriber devices via a wireless network.

In one embodiment, a server 101 may comprise, or may be operatively coupled to interact with, one or more storage device or means for storing one or more application 110 and one or more database 120. In one embodiment, more than one server 101 may be linked to form a “community” of servers, applications, databases, and services. In one embodiment, an application 110 may be uploaded to a server 101 as a package comprising one or more of the following: a JAR Java Archive (JAR) containing an application Suite and its associated Resources, an associated application descriptor file (JAD file), upload time developer selected configuration information (e.g. category, networks, supported devices), and/or optional source code and screen shots of the application. In one embodiment, packaging applications in JAR format permits application 110 manifest information and descriptor information to be stored in a database 120 for subsequent indexing. Application descriptor information may be used by search engines looking for applications with particular name, provider, size, capabilities and/or functionality. Other resources that may be uploaded, alone, or with an application 110, include, for example, other applications, enhancements specific to the requirements of devices and users in the network 100, documentation, proprietary API's, etc. In one embodiment, one or more application 110 may be embodied to comprise a Java MIDlet, and/or a Java MIDlet Suite, etc. Although described above to comprise specific embodiments, each application 110 may comprise or may be subsequently modified to include greater, fewer, or different resources and should, thus, be limited only by the claims as recited below.

Server 101 may comprise the backend for a network connected information server, for example, a web site supporting WAP, HTML, XHTML, cHTML, XML, etc. Just as webservers may be used to host PC-based application servers, a web site as described herein may contain webpages and links to webpages and other application resources it can deliver to devices 140 and their users.

One or more database 120 may store information that may include, but is not limited to, individual user preferences/characteristics, a log of recently downloaded applications, a log of most frequently used applications, billing and subscription info, user ranking of applications, applications used in the past by a user, history of downloads, and user device capabilities/characteristics. User device capabilities/characteristics may include, but are not limited to, display screen size/resolution/color depth; memory size (total and remaining); user interface capabilities and related APIs; text, touch, biometrics, speech recognition, handwriting recognition, image capture, input, output, audio, and vibrate capabilities; processor type and processor features; processor optimizations possible; current applications installed; Java and Java-like virtual machine manufacturer and version; etc. The device capabilities/characteristics (and possibly the user preferences as well) may be integrated with a Jini architecture to provide service and capability discovery. In one embodiment, user preferences and device capabilities may be implemented using the Composite Capability /Preference Profile (CC/PP) currently being developed by the World Wide Web Consortium (W3C) and described at: http://www.w3.org/TR/NOTE-CCPP/. In one embodiment, database 120 may be provided in a form (x.500 for example) accessed by industry standard LDAP (Lightweight Directory Access Protocol) and the Java specific JNDI (Java Naming and Directory Interface) application programming interface (API). In one embodiment, as permitted or needed, each database 120 may be made accessible not only to server 101, but to individual users, devices, developers, service providers, and/or content providers in network 100.

One or more database 120 may be used to store communications from devices 140 and/or their users, including communications that indicate whether a particular user has saved or deleted an application after using it, thereby providing statistics that may assist in tracking user preferences and in ranking applications (those apps which are saved by users will be more highly rated and generally more valuable as compared to those users don't give up precious local storage to and simply delete after use). Content and/or service provider ratings of applications as well as download statistics may also be stored in database 120 and may be used in selecting the best software for use by a device 140 or user. By searching the log of other users of an application (AppA), and examining other applications that have been rated highly by these other users, download logs matched by user and preferences may allow other users and service providers to find applications based on a method that uses current applications (AppA) they like as a key to find related applications (AppB) or other highly rated applications (AppC, AppD, etc.). To compensate for the limited display, storage and network bandwidth capabilities of mobile devices, a log of the frequency of download of applications may aid users in finding popular applications, and in ranking and narrowing user search results.

Information stored in database 120 may be used to optimize device 140 interactions with applications 110, as well as to optimize interactions between, and performance of, server 101, and/or devices and/or users registered thereto. For example, information stored in database 120 may reduce the need for a device 140 and/or the device's user to search repository server 101 more than once for an application 110 that a user may have used in the past, but could not store on his/her device. More rapid access to applications stored on repository server 101 may thereby be facilitate to conserve processing resources and power of both the network 100 and devices 140 therein. In one embodiment, database 120 or other information repository mechanism may store copies of applications 110 used by particular users in the past. In this way, the memory size of the device 140 may be increased by providing devices in network 100 with extra accessible memory implemented in a lower cost persistent storage medium. In one embodiment, database 120 or other information repository mechanism, or local storage on device 140 may store a list of short cut paths to applications used in past by the operator of the device. The short cut list may include a listing of the applications and the paths to the actual applications. The listing may be called up by users to access applications used in the past. In one embodiment, the list may be sorted in a number of ways, including, but are not limited to date application was last used, application title, application source, application function or type, application size, application rating, frequency of use, and application cost.

In one embodiment, database 120 may comprise a listing of registered device 140 types. The listing may utilize a standardized means of specifying device type and capabilities. The listing may be made accessible to service providers, carriers, etc, as needed or requested. In one embodiment, manufacturers may update the database 120 to add information about their device 140 types through secured access provided to them by an administering body. The information may include model number, processor capabilities, memory configurations and size, base software loaded, standards supported, etc. Device capabilities may be accessed from this industry database via product model number, and this information may be used by service providers, content creators, or users subscribing to the service to tailor individual applications 110 in real-time to the unique capabilities of particular devices 140 in network 100. Manufacturers may request and may be assigned a unique identifier code by the administering body for each of their products and product variants to act as a search tag into the database 120. The unique device identifier or model number may be accessible by way of query from a service provider or may be provided by a device or user during a request for services or application download. Manufacturers may add new information or request identification numbers through an automated interface such as a web browser and related security interface. In one embodiment, the server 101 may be replicated worldwide to provide faster access to service providers who wish to make use of the device identification and capabilities database. Database 120 may be distributed and updated periodically using methods well known to those skilled in the art. In one embodiment, the administering body may be a service provider that also provides application optimization facilities based on supported devices capabilities. In one embodiment, the capabilities look-up methods proposed by the MExE group as currently defined at: http: / /www.3gpp.org/ftp/Specs/2001-03/Rel-4/23series/23057-410.zip may be extended to provide required functionality. In one embodiment, the User Agent Profiles (UAProf) (http: / /www1.wapforum.org/tech/terms.asp?doc=WAP-174 003-UAPROF-20010208-a.pdf)being defined by the WAP Forum (http://www.wapforum.org ) specification may be extended to provide required functionality. In one embodiment, the CC/PP specification (http://www.w3.org/Mobile/CCPP/ ) being defined by the W3C may be used to manage device profile information. In one embodiment, unique device identifier and unique manufacturer identifiers, as defined by the Bluetooth Special Interest group (http: / /www.bluetooth.com), may be used to index the database 120.

Server 101 may also include or be operatively coupled to a Java application search/indexing engine 103 and/or to a user interface (not shown) on device 140 that may be used to search the server 101 and/or the WWW for requested applications. As the number of servers 101 increase, the search or indexing engine 103 of any particular server 101 may provide the appearance of a central repository by extending the search domain to any number of repositories 101 located in the network 100 and by providing a single search utility to users of devices 140. A community of servers 101 combined with intelligent searching and indexing targeted at registered users may allow for simple one click user access to applications and services. Searches of descriptor files accompanying each application file, which in one embodiment may be MIDlet files, may be conducted by keyword, name, version, vendor, etc. MIDlet-Info-URL information may also be fetched/ spidered to have more criteria to search from. Engine 103 may be used to find upgrades to existing applications registered users have used, for example, based on a query of the user's device, based on a user profile sent at the time of search, or via a user profile stored on a database 120. In one embodiment, users may be automatically informed of new versions of applications that they use or wish to use via a mechanism where when a new version of an application 110 is uploaded to the repository server 101, and when a user has indicated they wish to be notified of new versions via a user profile log on database 120, the user is be notified. User profile logs of existing users stored in database 120 may also be searched by application providers and alerts sent to their devices to indicate that a new version of an application is available. Notifications may also provide a direct link to allow users to upgrade automatically or with a single action. In one embodiment, users in the network 100 may access applications and services as indexed by the engine 103, and based on the indexing of the applications and services, the engine 103 may suggest and personalize future applications and services. The search engine 103 results may be presented to the user through a browser using WAP/WML, cHTML, xHTML, etc. or some other suitable format. In one embodiment, the search engine 103 front end may be a stand-alone application running on a user's device and may include search of local device memory, as well as network accessible repositories including any extension of devices storage capacity via network-based storage media. In one embodiment, the front end of the search engine 103 application may be distributed with the user interface resident on the user's device, and the remainder of the search engine application may be located in the network 100. In one embodiment, a search engine 103 interface may be implemented through a browser using xHTML, WML, CHTML, HTML, XML, Java, etc.

Access to, and use of, server 101 and engine 103 may be integrated in Java application management 105 (JAM) extensions in the software or operating system of a device 140. At a user's option to add or upgrade an application 110 on his device, a “search path” could be used. In one embodiment, the “search path” may be customized by a service provider, device manufacturer, or wireless carrier, to provide prioritized search access to applications and services best suited to the capabilities of a device 140, user preferences, service package subscribed to, or applications currently being promoted by the application's provider. In one embodiment, a default search path may be dynamically reconfigurable. Advanced “cross” searches for more apps from the same vendor may also be integrated so that users may readily find applications from a particular vendor (for example, a service provider) in the anticipation that these new applications will have the same quality and utility. In one embodiment, providers, for example, carriers/content/service providers may be able to have push control over the search path. In one embodiment, a 3rd party's server 101 could be added to a user's search path (possibly with appropriate license fees paid).

Server 101 may also include or be operatively coupled to a tool 107. Tool 107 may be implemented in hardware, firmware, and/or software encoded on a computer readable medium. A computer readable medium is any medium known in the art capable of storing information. Computer readable media include Read Only Memory (ROM), Random Access Memory (RAM), flash memory, Erasable-Programmable Read Only Memory (EPROM), non-volatile random access memory, memory-stick, magnetic disk drive, floppy disk drive, compact-disk read-only-memory (CD-ROM) drive, transistor-based memory or other computer-readable memory devices as is known in the art for storing and retrieving data.

In one embodiment, tool 107 may reside on server 101, or as an intermediary between server 101 and end users and/or application developers, so that applications and services submitted to server 101 and/or a device 140 by developers, content providers, etc., would be subject to qualification, processing, optimization, and/or customization by the tool. Although such qualification, processing, optimization, and/or customization is described below with reference to specific embodiments, it is understood that other embodiments are within the scope of the present invention and, thus, the present invention should be limited only by the claims below.

In one embodiment, to ensure each application 110 will run properly, tool 107 may be used to qualify and profile one or more application 110 before upload to an execution environment of a device 140. In one embodiment, one or more application 110 may be stored on server 101 after it is qualified for one or more device 140 in the network 100. In one embodiment, after qualification, but before storage on server 101, developers may submit applications 110 for further analysis, optimization, processing, and/or customization. In one embodiment, an application 110 may be analyzed, optimized, processed, and/or customized by tool 107 after storage, but before upload to a device 140. In one embodiment, applications 110 may be analyzed, optimized, processed, and/or customized according to individual device or user preferences stored on one or more database 120.

In one embodiment, tool 107 may comprise an execution/optimization module 156. Module 156 may be used to pre-execute applications 110 to optimize their operation prior to storage or upload to server 101 and/or a device 140. In one embodiment, optimization may include byte-code removal, alteration, addition, and/or replacement. In one embodiment, optimization may include removal or addition of resources from an application 110, for example, removal of audio files from an application to be deployed to registered devices 140 that do not comprise audio playback capabilities.

In one embodiment, tool 107 may use other modules to deterministically, or otherwise, pass, reject, analyze, optimize, profile, process, and/or customize applications 110 and/or other information submitted to the server 101. In one embodiment, tool 107 may comprise a class file verification module 151, a byte-code analysis module 152, an authentication module 153, a compatibility module 154, and/or a data-mining module 155. In one embodiment, tool 107 may determine which modules need to be applied to submitted applications 110, may determine any dependencies that may exist between modules, and may resolve the dependencies such that operations occur in such an order so as the effects of one operation does not hinder the completion of another. The modules need not necessarily exist and execute in or on the same server 101. For example, for performance sake, it may in some cases make sense to have a different modules executing on a different servers. For dynamic loading of modules, however, tool 107 should be aware of the location of needed modules on other servers, for example, through a registry operatively coupled to the server 101.

In one embodiment, class file validation of an application 110 may be performed with module 151. Doing so may compensate for limited class file verification facilities that may be present on a device 140. In one embodiment, tool 107 may check for stack maps to see if a particular application 110 has already been pre-verified for execution upon a device 140. If not, then pre-verification may be done, and stack maps may be inserted into class files.

Tool 107 may also be used to check for non-standardized method calls needed to run an application 110 on a device 140. Required library support may be stored on the server 101 and may be uploaded on the fly to each device 140 as needed. For example, if an application 110 needed a device or network specific API not resident on a device 140, for example in its CLDC or MIDP, libraries and services stored on server 101 could be polled, and provided as needed to the device. In one embodiment, the poll results may be stored in database 120 and may be provided back to application developers to act as Technology Compatibility Kit done at application deployment time. The concepts discussed above may be extended to include bundling chunks of program code used by a device's co-processor or host processor. For example, a video player may be bundled with DSP processor code that may be required to decode/load/run an incoming video stream via an API between a Java application and a DSP processor residing on a device 140.

In one embodiment, module 152 may analyze the byte-code of each application 110 submitted to server 101 and may profile each application on database 120 to provide indications of what types of resources may be required for execution by what application. For example, passes over the byte-code may be used to analyze applications for heap memory and code hotspots. Based on the analysis, if the needed resources are stored on server 101, they may be uploaded to each device along with the application that was analyzed. In one embodiment, as optimally determined by module 152 for different sections of an application 110, or for execution of an application as a whole, an analysis of byte-codes present in an application may be used to selectively boost a device's processing speed.

In one embodiment, possible extended op-codes and corresponding microcode may be stored in a database and/or on server 101. During analysis of an applications byte-code, it may be determined that there may be appropriate extended op-codes that could be used to provide improved and optimized performance during execution of the application on a particular device 140. In one embodiment, the extended op-codes may be downloaded alongside an application 110 to dynamically reprogram the micro-code of a particular device 140. By offloading such an analysis to the server 101, a pre-stored application 110 may be optimized prior to download to a device 140 to provide optimal user experience vs available device processing and power resources.

In one embodiment, multi-byte NOP instructions may be defined through analysis of an application 110. Common instruction sequences may be identified and folded into a modified instruction of an application 110 uploaded to a device 140, so as to reduce the number of machine clocks required to perform the operations in an execution sequence. The multi-byte NOP op-codes may be defined by the holes created by selected folding routines, so as to cover any holes with a single multi-byte NOP with only a single machine clock. Where instruction set space is limited (i.e. few remaining op-code numbers), fewer multi-byte NOP op-codes may be defined. In such cases, a single hole may be covered using more than one multi-byte NOP instruction. For example, two two-byte NOP instructions may be used to replace a four-byte hole if a four-byte NOP instruction is not available in an instruction set

In one embodiment, one or more classes contained in one or more MIDlet to be downloaded to a device 140 may be profiled by server 101. The profile results may be used to identify common instruction sequences that may be folded into new modified or pre-exiting instructions of the instruction set of a device's processing hardware. As needed, new modified op-codes and multi-byte NOP op-codes may be downloaded into the instruction set of a device 140 prior to loading a profiled application 110, after which the profiled application 110 may be downloaded into the run-time system of the device. In one embodiment, server 101 may deliver an application 110 that comprises instruction substitutions as well as any insertions of multi-byte NOPs already performed using the new modified op-codes and multibyte NOP codes in the instructions set of the device. In another embodiment, the class loader may also be modified, the class loader performing the instruction substitutions.

In one embodiment, tool 107 may be used to analyze the branch instructions of an application 110, and the analysis results may be provided to device 140 to optimize the application's execution on the device. In one embodiment, application execution speed may be optimized by dynamically mapping the branch instruction op-codes of an application to a specific branch prediction scheme, as is described in commonly assigned U.S. patent application Ser. No. 09/829,235 filed on Apr. 9, 2001.

In one embodiment, compatibility module 154 may be used by developers, content providers, users, etc. to pre-execute an application 110 on one or more processor specific simulator residing on the server 101. Each simulator may mimic the operations of various processors of devices in the network 100. In one embodiment, OEMs may write and submit their own modules to a test suite on server 101, which may be set up to use their proprietary extension APIs. In one embodiment, mobile device 140 and/or user configurations (processor type/ version, memory configuration, current applications stored, I/O capabilities, etc.) saved on server 101 in database 120 could be used to configure the simulator. The simulator may thereafter be used to pre-execute a submitted application 110 in a test “sand box” to verify proper operation of the application for particular mobile devices and/or for particular user environments, and/or to verify no adverse interaction with other applications users might be using, wish to use, or are predicted to use. For example, because of the trend towards deployment of many different clean room Java-like virtual machine versions (for example Chai from Hewlett Packard, J9 from IBM, etc.), the VM manufacturer version, as well as the stored extensions/profiles/configurations of particular registered devices, may be pre-qualified with tool 107 to ensure a particular application 110 will run properly before the actual deployment of a new VM to the server 101 in network 100. Also, given the existence of various VMs or implementations of VMs with specific extensions/profiles/configurations in each device 140 in network 100, new applications 110 may also be pre-qualified with tool 107 to ensure they will function properly in network 100, for example, with individual devices, a class of devices, or classes of devices.

In one embodiment, authentication module 153 may be used to verify the authenticity of an application 110 via a digital signature, for example, via a third party e.g. Verisign. Module 153 may also use an internal digital signature to uniquely identify an application 110. Tool 107 may also be used to test adherence of an application 110 to industry standards such as the MExE security policies or other custom policies defined by a carrier of service provider using network 100 as an infrastructure. Service providers and carriers may define and upload policy requirements to a network by using standard templates and an automated process. The ability to provide transport security an cryptography with an application 110 may ensure it is not tampered with during delivery to a registered device 140, as well as to ensure a device does not load any applications claiming to be an approved application, but which are not. Authentication module 153 may also be used to check applications for virus infection prior to upload of the application to a requesting device 140, thereby eliminating the need to store virus applications on limited memory devices.

In one embodiment, data mining module 155 may be used by users, developers, OEMs, service providers, and content providers to retrieve information from server 101 and or database 120 as needed to develop and/or submit applications.

In one embodiment, a business, for example, “JavaToGo.com”, may provide a centralized server 101 for developers to send applications for distribution (sale, lease, etc.) to users and to provide pre-qualification and customization to optimize the applications for use by registered devices 140. Such a business model may build a strong business relationship between the mobile device users 140 and the service provider (client-server relationship). In one embodiment, the server 101 may be “hidden” in the background and may be provided to a wireless carrier/operator company, which may apply its own branding. In this case, a strong business relationship may develop between the user 140 and the carrier from which the user purchases mobile services and airtime. This in turn may build a highly desired “stickiness factor” to prevent users from switching carriers and may build wireless network usage and revenues for the carrier/operator company. The business can be further built by providing the developers a suite of tools to write mobile applications for the server 101.

Referring now to FIG. 2, there is seen how free or low cost access to development tools and special incentives could be provided with or on the server 101 to build the developer community.

Although the embodiments herein are described with reference to specific embodiments, it is understood that with appropriate modifications and alterations, the scope of the present invention encompasses embodiments that utilize other features and elements, including, but not limited to other Java or Java-like languages, environments and software instructions similar in functionality to that of Java described herein, for example, Common Language Interchange (CLI), Intermediate Language (IL) and Common Language Run-time (CLR) environments and C# programming language as part of the .NET and .NET compact framework, available from Microsoft Corporation Redmond, Wash.; Binary Run-time Environment for Wireless (BREW) from Qualcomm Inc., San Diego. Thus, it is understood that the present invention should not be limited by the description contained herein, but only by the claims that follow.

What is claimed is:

1. A system for disseminating information to users and devices in a network, the system comprising:
a server, the server comprising Java information, wherein the server disseminates the Java information to the users and devices in the network, wherein the Java information is disseminated to users and devices based on characteristics of the users and the devices;
at least one computer readable medium for storing the characteristics of the users and devices;
and a tool, wherein each computer readable medium, the tool, and the server are operatively coupled, wherein the tool processes the Java information based on the characteristics of the users and devices prior to dissemination.

2. The system of claim 1, wherein the Java information comprises information submitted to the server by application developers.

3. The system of claim 1, wherein the Java information comprises information submitted to the server by content providers and service providers.

4. The system of claim 1, wherein the server disseminates the characteristics of the users and devices in the network to providers of the information.

5. The system of claim 1, wherein the Java information comprises one or more application, wherein the computer readable medium further comprises characteristics of the one or more application, and wherein the server disseminates one or more of the characteristics to the network.

6. A system for disseminating information, the system comprising:
a server for storing Java information; and
a plurality of mobile communication devices, wherein the server disseminates the Java information to the mobile communication devices according to characteristics of the mobile communication devices.

7. The system of claim 6, further comprising a tool, wherein the information comprises byte-codes, and wherein the tool is operatively coupled to the server, and wherein the tool processes the information by changing at least some of the byte-codes.

8. The system of claim 6, further comprising a tool, wherein the information comprises byte-codes, and wherein the tool processes the information by adding byte-codes to the information.

9. The system of claim 6, further comprising a tool, wherein the information comprises byte-codes, and wherein the tool processes the information by removing byte-codes from the information.

10. A server for disseminating information to devices in a network, comprising:
a tool, the tool for receiving information and for processing the information according to characteristics of the network, wherein the characteristics comprise characteristics of the devices.

11. The system of claim 10, wherein the devices comprise mobile communication devices.

12. The server of claim 10, wherein the characteristics of the devices are selected from a group consisting of display, memory, interface, processor, and installed software characteristics.

13. A server for disseminating information to users in a network, comprising:
a tool, the tool for receiving information and for processing the information according to characteristics of the network, wherein the characteristics comprise characteristics of the users.

14. The server of claim 13, wherein the characteristics of the users are selected from a group consisting of download history, log of frequently used applications, billing and subscription info, user ranking of applications, applications used in the past, and download history.

15. A method for disseminating information in a network, the method comprising the steps of:
providing information to the network as byte-codes;
processing the byte-codes according to characteristics of the network; and
disseminating the processed byte-codes to the network.

16. The method of claim 15, wherein the step of processing comprises adding byte-codes to the information, removing byte-codes from the information, or altering the byte-codes.

17. A method for disseminating information in a network, the method comprising the steps of:
providing Java information to a server in the network;
processing the Java information according to characteristics of the network; and
disseminating the processed Java information to the network.

18. The method of claim 17, further comprising the step of processing the Java information by processing byte-codes of the Java information.

19. The method of claim 17, further comprising the step of processing the information by qualifying, profiling, optimizing, or customizing the information.

20. The method of claim 17, further comprising the step of removing or adding resources to the Java information, and wherein the characteristics of the network comprise characteristics of devices and users in the network.

21. A method for disseminating information in a network, the method comprising the steps of:
providing a JAR file to the network;
processing the JAR file according to characteristics of one or more mobile devices in the network; and
disseminating the processed JAR file to one or more mobile devices in the network.

22. A method for disseminating information to devices and users in a network, the method comprising the steps of:
providing Java information to the network;
optimizing the Java information according to characteristics of users and devices in the network;
disseminating the processed Java information to the users and devices.

23. A method for disseminating information to devices and users in a network, the method comprising the steps of:
providing Java information to a server in the network;
qualifying the Java information; and
disseminating the qualified Java information to the users and devices.

24. A method for disseminating information to devices in a network, the method comprising the steps of:
storing Java information in the network to server;
storing characteristics of a specific users and devices in the network to the server;
disseminating the Java information in the network to specific users and devices in the network according to the characteristics of the specific users and devices.

25. A computer readable medium, comprising: program instructions, wherein the program instructions interact with a network to receive Java or Java-like information and to process the information according to characteristics of the network, wherein the characteristics comprise characteristics of devices in the network.

26. The computer readable medium of claim 25, wherein the program instructions interact with the network to disseminate the processed information to the network.

27. A system for disseminating information to users and devices in a network, comprising:
means for registering users and devices in the network;
means for receiving information;
means for processing the information based on characteristics of the users and devices in the network; and
means for disseminating the processed information to the network.
